(19) United States
(12) Patent Application Publication
(10) Pub. No.: US 2018/0312422 A1
(43) Pub. Date: Nov. 1, 2018

(54) METHOD OF CUTTING A LAMINATE GLASS ARTICLE

(71) Applicant: Corning Incorporated, Corning, NY (US)

(72) Inventors: Anatoli Anatolyevich Abramov, Painted Post, NY (US); Richard Bergman, Horseheads, NY (US); Vladislav Yuryevich Golyatin, Avon (FR); Ritesh Satish Lakhkar, Painted Post, NY (US); IIia Andreyevich Nikulin, Painted Post, NY (US)

(73) Assignee: Corning Incorporated, Corning, NY (US)

(21) Appl. No.: 15/524,725

(22) PCT Filed: Nov. 6, 2015
(86) PCT No.: PCT/US15/59366

§ 371 Date: May 5, 2017

Related U.S. Application Data
(60) Provisional application No. 62/076,853, filed on Nov. 7, 2014.

(51) Int. Cl. C03B 33/02; C03B 33/07; C03B 33/09; C03B 33/033; C03B 17/02

(52) U.S. Cl. CPC C03B 33/0222; C03B 33/076; B32B 17/06; C03B 33/033; C03B 17/02; C03B 33/091

(57) ABSTRACT

A method of cutting a laminate glass article is disclosed. The method comprises heating at least a portion of a laminate glass article to a reheat temperature. The laminate glass article has a core layer and a first cladding layer and is in stress characterized by a thermally-induced differential stress between the core layer and first cladding layer. The laminate glass article having been set at a setting temperature and the reheat temperature is lower than the setting temperature. The heating of the laminate glass article reduces the thermally-induced differential stress between the core layer and first cladding layer. The method may further comprise scoring the laminate glass article in the heated portion to create a score in the laminate glass article along a cutting line and bending the laminate glass article at the score to cut the glass.

This application claims the benefit of priority to U.S. Application No. 62/076853 filed on Nov. 7, 2014 the content of which is incorporated herein by reference in its entirety.

### BACKGROUND

### 1. Field

The present disclosure generally relates to methods for separating laminate glass articles and, more specifically, to methods for separating laminate glass articles by tension and compression manipulation.

### 2. Technical Background

Glass articles, such as cover glasses, glass backplanes and the like, are employed in both consumer and commercial electronic devices such as LCD and LED displays, computer monitors, automated teller machines (ATMs) and the like. Some of these glass articles may include “touch” functionality which necessitates that the glass article be contacted by various objects including a user's fingers and/or stylus devices and, as such, the glass must be sufficiently robust to endure regular contact without damage. Moreover, such glass articles may also be incorporated in portable electronic devices, such as mobile telephones, personal media players, and tablet computers. The glass articles incorporated in these devices may be susceptible to damage during transport and/or use of the associated device. Accordingly, glass articles used in electronic devices may require enhanced strength to be able to withstand not only routine “touch” contact from actual use, but also incidental contact and impacts which may occur when the device is being transported.

The required enhanced strength may be provided by a laminate strengthened glass article having a glass core and at least one glass cladding layer fused to the glass core layer. Such a laminate strengthened glass article may provide the enhanced strength required by the consumer and commercial electronic devices mentioned above. The core layer of such a laminate strengthened glass typically has a core coefficient of thermal expansion CTE_{core} different from that of the cladding, CTE_{cladding}. As a result of the different coefficients of thermal expansion, the laminated glass article is in stress, with one layer in tension and the other in compression. When the laminated glass article is in stress, it may be difficult to cut accurately.

### SUMMARY

According to some embodiments, a method of cutting a laminate glass article comprises heating a laminate glass article to a reheat temperature. The laminate glass article has a glass core layer with a first surface portion and a second surface portion that is opposite from the first surface portion, and at least one glass cladding layer fused to the first surface portion or the second surface portion of the glass core layer. The glass core layer has an average core coefficient of thermal expansion CTE_{core}, and the at least one glass cladding layer has an average cladding coefficient of thermal expansion CTE_{cladding} which is less than or greater than the average core coefficient of thermal expansion CTE_{core}. The differences in CTE result in a thermally-induced differential stress between the core layer and cladding layer. The laminate glass article having been set at a setting temperature and the reheat temperature is lower than the setting temperature. Heating the laminate glass article to the reheat temperature reduces stress in the portion of the laminate glass article that is heated. The method can further comprise scoring the laminate glass article along a cutting line, which is the line of the desired cut in the laminate glass article. The method can further comprise bending the laminate glass article to separate the laminate glass article into the desired cut pieces.

According to some embodiments, a method of cutting a laminate glass article comprises heating at least a portion of the laminate glass article to form a heated portion. The laminate glass article comprises a core layer and a cladding layer adjacent to the core layer. Prior to the heating, the laminate glass article comprises a stress resulting from a thermal property differential between the core layer and the cladding layer. The stress of the laminate glass article is reduced in the heated portion in response to the heating. The laminate glass article is scored in the heated portion to create a score in the laminate glass article along a cutting path. The cutting path defines a path in the laminate glass article where the cut is desired. A force is applied to the laminate glass article at the score to cut the laminate glass article.

According to some embodiments, a method of cutting a laminate glass article comprises heating at least a portion of the laminate glass article to form a heated portion. The laminate glass article comprises a core layer disposed between a first cladding layer and a second cladding layer. The laminate glass article comprises a coefficient of thermal expansion (CTE) mismatch between the core layer and each of the first cladding layer and the second cladding layer such that, prior to the heating, the laminate glass article comprises a stress. The stress of the laminate glass article is reduced in the heated portion in response to the heating. The laminate glass article is scored in the heated portion to create a score in the laminate glass article along a cutting path. The cutting path defines a path in the laminate glass article where the cut is desired. The laminate glass article is bent at the score to sever the laminate glass article.

According to some embodiments, a system comprises a heating unit configured to heat at least a portion of a laminate glass article to form a heated portion. The laminate glass article comprises a core layer and a cladding layer adjacent to the core layer. Prior to the heating, the laminate glass article comprises a stress resulting from a thermal property differential between the core layer and the cladding layer. The heating unit is configured to reduce the stress of the laminate glass article in the heated portion. A scoring unit is configured to score the laminate glass article in the heated portion and create a score in the laminate glass article along a cutting path. The cutting path defines a line in the laminate glass article where a cut is desired. A severing unit is configured to apply a force to the laminate glass article at the score to sever the laminate glass article.

Additional features and advantages of the methods for cutting laminate glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of one embodiment of a laminated glass article according to one or more embodiments shown and described herein.

FIG. 2 schematically depicts one embodiment of a fusion draw process for making the laminated glass article of FIG. 1.

FIG. 3 is a top view of a laminated glass article being cut according to one embodiment of the present disclosure.

FIG. 4 is a side view of a laminated glass article being cut according to one embodiment of the present disclosure.

FIG. 5 is a top view of a laminated glass article being cut according to one embodiment of the present disclosure.

FIG. 6 is a side view of a laminated glass article being cut according to one embodiment of the present disclosure.

FIG. 7 is a side view of a laminated glass article being cut according to one embodiment of the present disclosure.

FIG. 8 is a top view of a laminated glass article being cut according to one embodiment of the present disclosure.

FIG. 9 is a cross-sectional picture of a laminated glass article cut according to the present disclosure compared with a laminated glass article cut at room temperature.

### DETAILED DESCRIPTION

Reference will now be made in detail to embodiments of methods for cutting laminate glass articles, examples of which are illustrated in the accompanying drawings. Whenever possible, the same reference numerals will be used throughout the drawings to refer to the same or like parts. As described in more detail below, embodiments provide for methods of cutting laminate glass articles by using lasers or other fast and local heating sources to manipulate tensile and compressive stresses along a desired line of separation.

Glass articles can be strengthened by thermal tempering and/or by ion exchange treatment. In such cases, the glass article can be subjected to additional processing steps after the glass article is formed, and these additional processing steps may increase the overall cost of the glass article. Moreover, the additional handling required to carry out these processing steps can increase the risk of damage to the glass article, which can decrease manufacturing yields and can further increase production costs and the ultimate cost of the glass article.

Laminate fusion draw is one method for producing glass articles (e.g., strengthened or non-strengthened glass articles). For example, in some embodiments, laminate fusion draw creates a three-layer laminate glass article having a core layer positioned between two cladding layers. In various embodiments, the laminate glass article comprises a glass sheet, a glass tube, or another suitable configuration. The glass types used for such a laminate fusion draw may result in a glass article with a core glass having a higher coefficient of thermal expansion than the cladding glass. Such an article comprises compressive stress in the cladding layers, counter-balanced by tensile stress in the core layer as the laminate strengthened glass article is cooled from annealing and strain point to a lower temperature. The strengthening via compressively stressed cladding layers provides additional damage resistance. The presence of damage resisting, compressively stressed cladding layers and a high center tension core can make the laminate strengthened glass article challenging to cut by traditional methods, such as mechanical scribe and separation methods, and laser scribe and separation methods.

The glass types may also be reversed resulting in cladding layers having a higher coefficient of thermal expansion than the core glass, resulting in compressive stress in the core, counter-balanced by tensile stress in the cladding layers. Such a laminate article also can be challenging to cut by traditional methods.

Referring now to FIG. 1, one embodiment of a laminated glass article 100 is schematically depicted in cross section. In the embodiment shown in FIG. 1, the laminated glass article 100 comprises a glass sheet. In other embodiments, the laminated glass article comprises a glass tube or another suitable configuration. The glass sheet can be substantially flat (e.g., planar) or curved (e.g., non-planar). Laminated glass articles may be cut during forming (e.g., at the bottom of a draw process), as well as after forming to separate a laminate glass article into a plurality of laminate glass articles or sheets. In various embodiments, the laminated glass article comprises a core layer and a cladding layer adjacent to the core layer. For example, in the embodiment shown in FIG. 1, the cladding layer comprises a first cladding layer 104a and a second cladding layer 104b, and a core layer 102 is disposed between the first cladding layer and the second cladding layer. Thus, the laminated glass article 100 generally comprises the glass core layer 102 and a pair of glass cladding layers 104a, 104b. It is noted that, in other embodiments, the laminated glass article may include only one glass cladding layer, thereby providing a two-layer article. In other embodiments, the laminated glass article may include multiple core and/or cladding layers, thereby providing a four-, five-, or more-layer article.

Still referring to FIG. 1, the laminated glass article 100 has a first surface 105 and a second surface 107. The glass core layer 102 comprises a first surface portion 103a and a second surface portion 103b, which is opposed to the first surface portion 103a. A first glass cladding layer 104a is fused to the first surface portion 103a of the glass core layer 102 and a second glass cladding layer 104b is fused to the second surface portion 103b of the glass core layer 102. The glass cladding layers 104a, 104b are fused to the glass core layer 102 without any additional materials, such as adhesives, coating layers or any non-glass material added or configured to adhere the respective cladding layers to the core layer, disposed between the glass core layer 102 and the glass cladding layers 104a, 104b. Thus, the first glass cladding layer 104a and/or the second glass cladding layer 104b are fused directly to the glass core layer 102 or are directly adjacent to the glass core layer 102. In some embodiments, the laminated glass article comprises one or more intermediate layers disposed between the glass core layer and the first glass cladding layer 104a and/or between the glass core layer and the second glass cladding layer 104b. For example, the intermediate layers comprise intermediate glass layers and/or diffusion layers formed at the interface of the glass core layer 102 and the glass cladding layer 104a, 104b. The diffusion layer can comprise a blended region comprising components of each layer adjacent to the diffusion layer. In some embodiments, the laminated glass article comprises a glass-glass laminate (e.g., an in situ fused multilayer glass-glass laminate) in which the interfaces between directly adjacent glass layers are glass-glass interfaces.

In some embodiments of the laminated glass article 100 described herein, the glass core layer 102 is formed from a first glass composition having an average core coefficient of thermal expansion CTE_{core} and the glass cladding layers 104a, 104b are formed from a second, different glass composition, which has an average cladding coefficient of thermal expansion CTE_{cladding}. The term “CTE,” as used herein, refers to the coefficient of thermal expansion of the glass composition averaged over a temperature range from about 20° C. to about 300° C. In some embodiments, the CTE_{core} may be greater than CTE_{cladding}, which results in the glass cladding layers 104a, 104b being compressively stressed without being ion exchanged or thermally tempered. Thus, the laminated glass article comprises a laminated strengthened glass article. In other embodiments, the CTE_{cladding} may be greater than CTE_{core}, which results in the core layer 102 being compressively stressed. In various embodiments, a thermal property differential (e.g., a CTE differential) results in stress within the core layer and/or the cladding layer of the glass article.

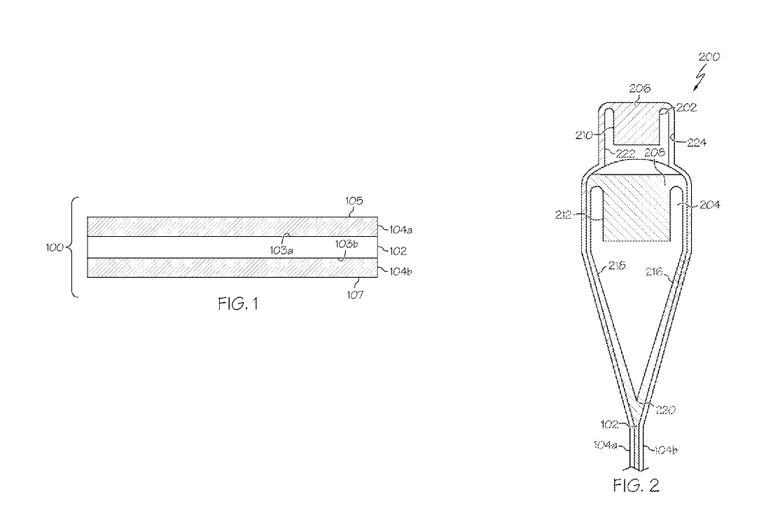

In some embodiments, the laminated glass articles 100 described herein may be formed by a laminate fusion draw or fusion lamination process such as the process described in U.S. Pat. No. 4,214,886, which is incorporated herein by reference in its entirety. Referring to FIG. 2 by way of example, a laminate fusion draw apparatus 200 for forming a laminated glass article comprises an upper isopipe or overflow distributor 202 which is positioned over a lower isopipe or overflow distributor 204. The upper overflow distributor 202 comprises a trough 210 into which a molten glass cladding composition 206 is fed from a melter (not shown). Similarly, the lower overflow distributor 204 comprises a trough 212 into which a molten glass core composition 208 is fed from a melter (not shown).

As the molten glass core composition 208 fills the trough 212, the molten glass core composition 208 overflows the trough 212 and flows over the outer forming surfaces 216, 218 of the lower overflow distributor 204. The outer forming surfaces 216, 218 of the lower overflow distributor 204 converge at a root or draw line 220. Accordingly, the molten glass core composition 208 flowing over the outer forming surfaces 216, 218 rejoins at the draw line 220 of the lower overflow distributor 204, thereby forming a glass core layer 102 of a laminated glass article.

Simultaneously, the molten glass cladding composition 206 overflows the trough 210 formed in the upper overflow distributor 202 and flows over outer forming surfaces 222, 224 of the upper overflow distributor 202. The molten glass cladding composition 206 is outwardly deflected by the upper overflow distributor 202, such that the molten glass cladding composition 206 flows around the lower overflow distributor 204 and contacts the molten glass core composition 208 flowing over the outer forming surfaces 216, 218 of the lower overflow distributor, fusing to the molten glass core composition and forming glass cladding layers 104a, 104b around the glass core layer 102. Thus, the molten glass core composition 208 in the viscous state is contacted with the molten glass cladding composition 206 in the viscous state to form the laminated glass article.

As noted hereinabove, in some embodiments of the present disclosure, the molten glass core composition 208 may have an average coefficient of thermal expansion CTE_{core} greater than the average cladding coefficient of thermal expansion CTE_{cladding} of the molten glass cladding composition 206. Accordingly, as the glass core layer 102 and the glass cladding layers 104a, 104b cool, the difference in the coefficients of thermal expansion of the glass core layer 102 and the glass cladding layers 104a, 104b cause compressive stresses to develop in the glass cladding layers 104a, 104b. The compressive stress increases the strength of the resulting laminated glass article without an ion-exchange treatment or thermal tempering treatment. Glass compositions for the glass core layer 102 and the glass cladding layers 104a, 104b may include, but are not limited to, the glass compositions described in PCT Pat. Publication No. WO 2013/130700 entitled “High CTE Potassium Borosilicate Core Glasses and Glass Articles Comprising the Same”, and PCT Pat. Publication No. WO 2013/130718 entitled “Low CTE Alkali-Free Boroaluminosilicate Glass Compositions and Glass Articles Comprising the Same”, both of which are assigned to Coming Incorporated and incorporated herein by reference in their entireties.

The theoretical discussion below is directed to a laminate article in which the core composition has an average coefficient of thermal expansion CTE_{core} that is greater than the average cladding coefficient of thermal expansion CTE_{cladding} of the glass cladding composition. The present disclosure, however, should not be understood to be limited by the following theoretical discussion. In other embodiments, the core composition has an average coefficient of thermal expansion CTE_{core} that is less than the average cladding coefficient of thermal expansion CTE_{cladding} of the glass cladding composition.

Without wishing to be bound by any theory, it can be assumed that, in a linear elastic body, stresses caused by different driving forces are additive. For example, in a case of uniform reheating of a laminate sample, stresses in the heated sample can be assumed to be a sum of the residual laminate stresses acquired during a manufacturing process and stresses generated by the reheating itself. Using the well-known stress formulae for stresses in elastic laminates, one can express the residual stresses as follows:

σ_{clad}^{res}=\tilde{E}_{clad}(α_{clad}−α_{core})(T_{ref}−Tᵣₒₒₘ),

σ_{core}^{res}=\tilde{E}_{core}(α_{core}−α_{clad})(T_{ref}−Tᵣₒₒₘ),

where \tilde{E}_{clad}, \tilde{E}_{core} are constants, which depend on elastic properties of constitutive materials and thickness ratio between core and clad layers of a laminate. α_{clad} and α_{core} are coefficients of thermal expansions for the materials. T_{ref}, Tᵣₒₒₘ, Tᵣₑₕₑₐₜ are the reference or setting temperature, at which stresses start to accumulate, room temperature and temperature of a reheated sample, respectively. Then stresses in a reheated sample can be calculated as

σ_{clad}^{final}=σ_{clad}^{res}+σ_{clad}^{reheat}=\tilde{E}_{clad}(α_{clad}−α_{core})(T_{ref}−Tᵣₑₕₑₐₜ),

σ_{core}^{final}=σ_{core}^{res}+σ_{core}^{reheat}=\tilde{E}_{core}(α_{core}−α_{clad})(T_{ref}−Tᵣₑₕₑₐₜ).

Since |T_{ref}−Tᵣₑₕₑₐₜ|<|T_{ref}−Tᵣₒₒₘ|, it is understood that the magnitude of stresses in a reheated laminate sample is lower than that in the same sample at room temperature. In the framework of the linear fracture mechanics, this relationship suggests that the magnitude of stress-intensity factors in the reheated sample will be lower as well. The latter follows from the linear relation between applied stresses and stress-intensity factors at a crack tip. It is believed that lower compressive stresses (and stress-intensity factors at a crack) in clad layers and lower tensile stresses in the core layer are beneficial for stable cutting. An explanation is that lower compression in the clad supports propagation of a score or vent, while lower tension in the core avoids uncontrolled breakage.

Considerations for the localized laser heating (e.g., by the CO₂ laser) are somewhat more complicated than for the application of uniform heating. It is believed that the CO₂ laser creates temperature gradients and a corresponding stress pattern, which supports crack propagation.

As further discussion, the temperature profile created by a laser Tₗₐₛₑᵣ=Tₗₐₛₑᵣ(x, y) in a single-layer sample is derived by through-thickness averaging of properties of constitutive materials for a laminate sample of interest. For example, we can introduce an effective CTE for the laminate sample as

$${α}_{eff} = \frac{{α}_{clad} \cdot 2 {t}_{clad} \cdot \frac{{E}_{clad}}{1 - {v}_{clad}} + {α}_{core} \cdot {t}_{core} \cdot \frac{{E}_{core}}{1 - {v}_{core}}}{2 {t}_{clad} \cdot \frac{{E}_{clad}}{1 - {v}_{clad}} + {t}_{core} \cdot \frac{{E}_{core}}{1 - {v}_{core}}} ,$$

where t_{clad}, t_{core} stand for thickness of clad and core layers correspondingly, E_{clad}, E_{core}—Young's Moduli and v_{clad}, v_{core}—Poisson ratios. In most cases, it can be assumed that the temperature profile in a laminate sample is close to Tₗₐₛₑᵣ(x, y). Then, stresses in a laminate sample being cut by the CO₂ laser can be expressed as

$${σ}_{clad}^{final} = {σ}_{clad}^{res} + {σ}_{clad}^{laser} = {σ}_{clad}^{res} + {σ}_{clad}^{reheat} + {σ}_{eff}^{laser} = {\tilde{E}}_{clad} ( {α}_{clad} - {α}_{core} ) ( {T}_{ref} - {T}_{laser} ) + {σ}_{eff}^{laser} , \\ {σ}_{core}^{final} = {σ}_{core}^{res} + {σ}_{core}^{laser} = {σ}_{core}^{res} + {σ}_{core}^{reheat} + {σ}_{eff}^{laser} = {\tilde{E}}_{core} ( {α}_{core} - {α}_{clad} ) ( {T}_{ref} - {T}_{laser} ) + {σ}_{eff}^{laser} .$$

In the formulae above, the laser-induced stresses in the clad and core layers, σ_{clad}^{laser} and σ_{core}^{laser}, are represented as a sum of stresses caused by re-heating of a laminate sample with a CTE mismatch from Tᵣₒₒₘ to Tₗₐₛₑᵣ and stresses σ_{eff}^{laser} caused by temperature gradients Tₗₐₛₑᵣ(x, y), which are the same as in the effective material with CTE equal to α_{eff}.

Similar to the case of uniform heating, we note that 0<|T_{ref}−Tₗₐₛₑᵣ|<|T_{ref}−Tᵣₒₒₘ|. Based on this relationship, it is believed that, in a laminate sample cut by the CO₂ laser, the “standard” laser-induced stresses are accompanied by additional laminate stresses, which are lower than the laminate stresses in the same sample at room temperature. Therefore, it is understood that CO₂-laser cutting of strengthened multi-layer samples has an advantage over a mechanical cutting due to the fact that the laser reheats glass and reduces the laminate residual stresses in the glass, which should be beneficial for cutting.

In addition to the analytical considerations, a finite-element model has been constructed, which illustrates the principle of superposition of stresses used above. Considering a ⅛-symmetrical model of a laminate sample with thickness ratio of 1 and following examplar thermo-mechanical properties (Young's modulus, Poisson's ratio, CTE, and reference temperature) of constituitive materials:

$${E}_{clad} = {E}_{core} = 70 GPa , {v}_{clad} = {v}_{core} = 0.22 , {α}_{clad} = 3 ppm / ° C . , {α}_{core} = 4 ppm / ° C . , {T}_{ref} = 722 ° C .$$

The room temperature is assumed to be Tᵣₒₒₘ=22° C., while the maximal temperature of re-heating by the laser Tₗₐₛₑᵣ^{max}=522° C.

The “laser-induced” temperature profile derived from the finite-element model shows that the center of the sample is hotter than the periphery. Since the center of the sample is hotter than the periphery, it should be under compression even though there are no constraints applied at the edges.

A calculated stress distribution in a laminate, but NON-strengthened sample under this loading condition was also considered. In this model, the center is under compression, though stresses in core and clad layers are different due to the CTE mismatch. The core layer experiences more compression because it has higher CTE and is supposed to expand more than the clad when the sample is reheated. The laser-induced stresses in a single-layer sample with effective CTE of α_{clad}=3.5 ppm/° C., laser-induced stress in a laminate strengthened sample, and non-disturbed laminate residual stresses at room temperature can be calculated. To simplify comparison of the results, stresses in core and clad layers for these cases are extracted at the axis of symmetry. The numerical results are summarized in the Table 1:

From comparison between rows 2 and 6, it is understood that laser-induced stresses in a strengthened laminate sample are indeed a sum of non-disturbed (taken at room temperature) residual laminate stresses and stresses due to the CO₂ heating. The latter is a sum of the stresses due to temperature gradients, the same as in a single-layer sample made of the effective material (row 1), and laminate stress caused by the temperature change at reheating (row 5). These observations illustrate the formulae above. Since laminate stresses should be proportional to temperature changes, we verify that the ratio of the stresses due to reheating from 22° C. to 522° C. (row 5) to the pure residual stresses caused by cooling from 722° C. to 22° C. (row 4) is equal to the ratio of corresponding temperature changes (rows 7, 8).

Thus the modeling exercise confirms the idea that the CO₂ cutting of laminates has actually a dual impact: it creates the stress pattern, which should support crack propagation, as in a single-layer sample, and it reduces the residual laminate stresses by the localized heating. This general understanding of the cutting process and actual cutting process data show that the reduction of the laminate stresses by heating leads to improvement of cutting capabilities compared to the cutting at room temperature.

In some embodiments, a method comprises heating at least a portion of a laminate glass article, such as that described above with a core layer and at least one cladding layer, to a reheat temperature. The laminate glass article comprises a thermally-induced differential stress between the core layer and first cladding layer resulting from the difference in the CTE_{core} and the CTE_{cladding}. In other words, the laminate glass article comprises a stress resulting from the CTE mismatch between the core layer and the cladding layer. Heating the laminate glass article reduces the stress of the laminate glass article in the portion of the laminate glass article that is heated. The laminate glass article may be scored in the heated portion along a desired cutting path. The cutting path can be straight (e.g., linear), curved (e.g., non-linear), or a combination thereof.

The laminate glass article may be subjected to non-localized heating or localized heating by, a suitable heating unit such as, for example, a laser beam. The laminate glass article may be scored by a suitable mechanical device, such as a score wheel, or a laser beam. If a laser beam is used for scoring, the scoring laser beam may be the same laser beam as the laser beam used to heat the laminate glass article, or it may be a different laser beam. A force (e.g., a severing force) can be applied to the laminate glass article at the score to cut or sever the laminate glass article. In some embodiments, applying the force comprises directing a cooling fluid toward the laminate glass article. For example, after the laminate glass article is scored, it may be subjected to cooling, by for example a water or air flow. In other embodiments, applying the force comprises bending the laminate glass article. For example, the laminate glass article may be bent at the score to cut the laminate glass article. For example, the laminate glass article is engaged by a bending unit that bends or flexes the glass article about the score such that a first portion of the glass article on a first side of the score moves relative to a second portion of the glass article on a second side of the score opposite the first side. Such relative movement can cause the glass article to separate at the score.

The benefits of the present disclosure result from any amount of sheet heating above room temperature (e.g.,, to the reheat temperature). In some embodiments, the heating decreases the stresses in the laminated glass article 100 by at least about 10%, at least 20%, at least 30%, at least 40%, or at least 50% relative to the stress prior to heating. For example, the heating reduces the tensile stress in the core layer by at least about 10% relative to the tensile stress in the core layer prior to the heating. Also for example, the heating reduces the compressive stress in the cladding layer by at least about 10% relative to the compressive stress in the cladding layer prior to the heating. Reducing the stress in the laminate glass article (e.g., by reducing the tensile stress in the core layer and/or reducing the compressive stress in the cladding layer) can help to enable cutting of the laminate glass article without breakage. Additionally, or alternatively, the reheat temperature does not exceed the setting temperature. As used herein, “setting temperature” refers to a temperature that is 25° C. higher than the strain point of the glass layer of the laminated glass article having the greatest strain point.

The benefits of the present disclosure are applicable to a laminate glass article as described herein, including a laminate strengthened glass article where the CTE_{core} may be greater than CTE_{cladding} and in which the core layer is in tension and the glass cladding layers are in compression.

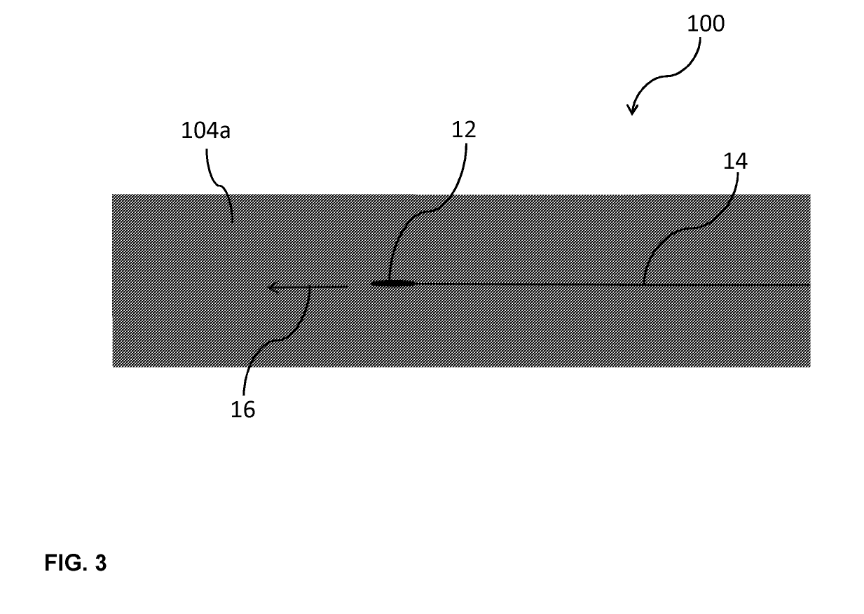

FIG. 3 is a top view of a laminated glass article 100 being cut according to one embodiment of the present disclosure. The laminated glass article 100 is shown with a non-localized sheet heating. For example, substantially the entire laminated article is heated to a reheating temperature. The heating is accomplished with a suitable heating unit (e.g., an oven, a kiln, a lehr, a furnace, or another suitable heating unit). As explained above, the sheet heating may reduce the stress in the laminated glass article 100. A score wheel 12 or another suitable scoring device scores the laminated glass article 100 at the reheating temperature, leaving a mechanical vent or score 14.

Scoring the laminated glass article at the reheating temperature can enable cutting of the laminated glass article with reduced breakage and/or improved edge quality compared to scoring the laminated glass article at room temperature. For example, such cutting can be enabled by the reduced stresses in the laminated glass article that result from heating the laminated glass article. The score wheel 12 moves relative to the laminated glass article 100 in the direction of scoring 16. The score 14 is a groove or channel formed in the surface of the laminated glass article. Once the score 14 is created in the laminated glass article 100, the laminated glass article 100 may be bent to sever the laminated glass article 100 at the score 14 to separate portions of the laminated glass article 100 disposed on opposing sides of the score 14.

The score 14 is shown penetrating through the cladding layer 104a and into the core 102. It will be understood, that the score 14 may penetrate through to the cladding layer 104b or merely partially into the cladding layer 104a, as desired. For example, the score 14 may penetrate merely partially into the cladding layer 104a, through the cladding layer 104a and into the core 102, or through to the cladding layer 104b, as desired.

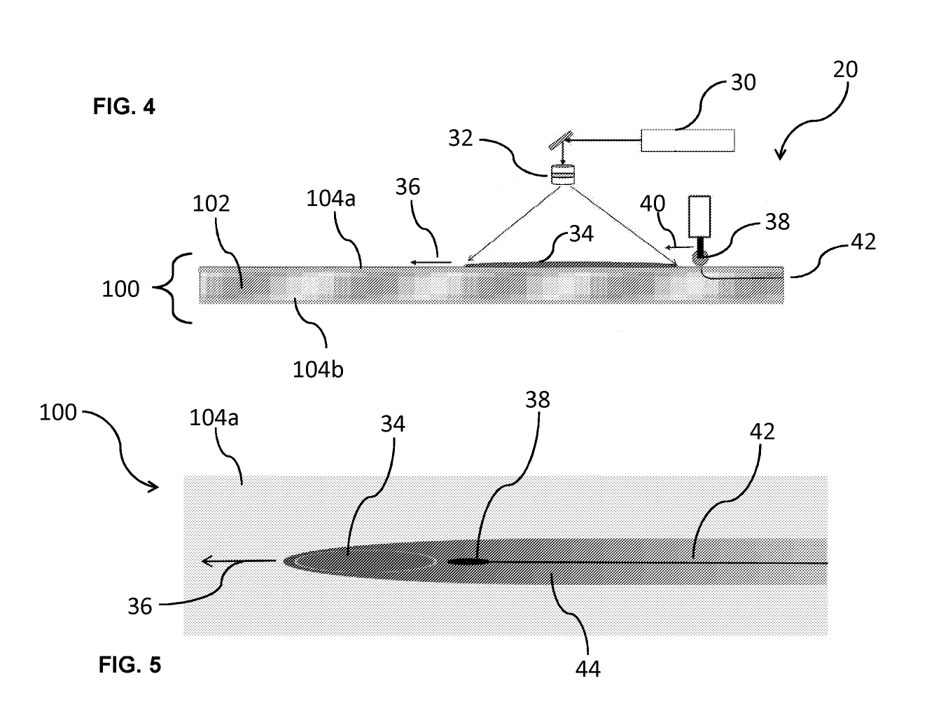

FIG. 4 is a side view of a laminated glass article 100 being cut according to one embodiment of the present invention. The embodiment of FIG. 4 uses a laser 30 and beam shaping optics 32 to focus a laser beam (pre-heat) 34 onto the cladding layer 104a of the laminated glass article 100. The laser beam (pre-heat) 34 moves relative to the laminated glass article 100 in the pre-heating direction 36. As will be understood, the laser 30 and beam shaping optics 32 may be stationary while the laminated glass article 100 is moved such that the laser beam (pre-heat) 34 provides heating in the pre-heating direction 36. Alternatively, the laminated glass article 100 may remain stationary while the laser 30 and beam shaping optics 32 are moved. Contacting the laminated glass sheet 100 with the laser beam (pre-heat) 34 preferentially heats a region of the laminated glass article to the reheat temperature to form a heated zone extending along the cutting line.

A score wheel 38 or another suitable scoring device may move in a scoring direction 40 to create a mechanical vent or score 42. For example, the score wheel 38 may contact the laminated glass article 100 along the heated zone to form the score 42 in the laminated glass article. Once the score 42 is created along the entire desired length of the laminated glass article 100, the laminated glass article 100 may be bent to separate the portions of the laminated glass article 100 at the score 42.

The score 42 is shown penetrating through the cladding layer 104a and into the core 102. It will be understood, that the score 14 may penetrate through to the cladding layer 104b or merely partially into the cladding layer 104a, as desired.

FIG. 5 is a top view of the laminated glass article 100 as it undergoes the mechanical scoring shown in FIG. 4. The laminated glass article 100 may be provided with heating localized to the desired location of cutting by the laser beam (pre-heat) 34. The laser beam (pre-heat) 34 provides the laminated glass article 100 with a laser heated zone 44. It is in this laser heated zone 44 that the score wheel 38 scores the laminated glass article 100 to create the score 42. The laser beam (pre-heat) 34 and the score wheel 38 progress in the pre-heating direction 36 to create a score 42 along the desired length of the laminated glass article 100. Scoring the laminated glass article at the laser heated zone can enable cutting of the laminated glass article with reduced breakage and/or improved edge quality compared to scoring the laminated glass article at a region outside of the laser heated zone.

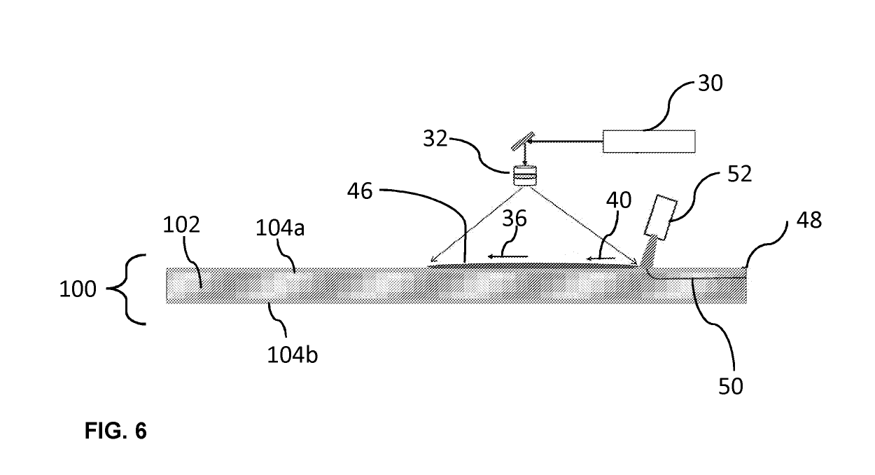

FIG. 6 is a side view of a laminated glass article 100 being cut according to one embodiment of the present disclosure. In the embodiment of FIG. 6, the laser beam 30 and the beam shaping optics 32 create a laser beam 46 on the cladding 104a of the laminated glass article 100 to both pre-heat and score the laminated glass article 100. The pre-heating direction 36 and the scoring direction 40 are both shown associated with the single laser beam 46 generated by the laser 30 and beam shaping optics 32 to reflect that a single laser beam 46 accomplishes both functions in this embodiment. The laser beam 46 creates a laser score in the cladding layer 104a of the laminated glass article 100. The laminated glass article 100 also may be provided with an initiation defect 48 to assist in the creation of the laser score 50 and later separation of the opposed portions of the laminated glass article 100.

As shown in FIG. 6, the laser score 50 penetrates through the cladding layer 104a and into the core 102. It will be understood that the laser score 50 may be adjusted to penetrate to any desired depth into the laminated glass article 100 including to the cladding layer 104b or merely into the cladding layer 104a.

A cooling nozzle 52 may also be utilized to cool the laminated glass article 100 after the laser score 50 has been created. For example, the cooling nozzle 52 may direct a cooling fluid (e.g., air or water) toward the laminated glass article at the score 50. Cooling the laminated glass article along the heated and scored portion thereof can thermally shock the laminated glass article to aid in severing the laminated glass article along the laser score.

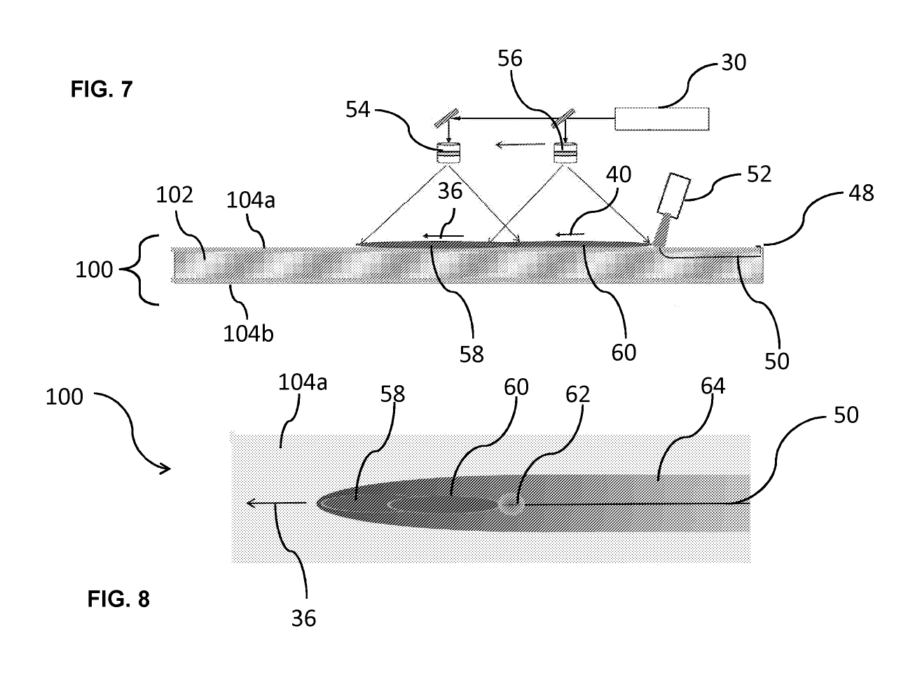

FIG. 7 is a side view of laminated glass article 100 being cut according to one embodiment of the present disclosure. The laser 30 works with a first beam shaping optics 54 to create a laser beam (pre-heat) 58 on the cladding layer 104a of the laminated glass article 100. Also, laser beam 30 works with a second beam shaping optics 56 to create a laser beam (score) 60 on the cladding layer 104a of the laminated glass article 100. The pre-heating direction 36 is shown associated with the laser beam (pre-heat) 58 to signify that the laser beam (pre-heat) 58 is used for the sole function of pre-heating the laminated glass article 100. The scoring direction 40 is shown associated with the laser beam (score) 60 to signify that the laser beam (score) is associated with the function of scoring the laminated glass article 100 to create the laser score 50.

The laser score 50 is shown penetrating through the cladding layer 104a and into the core 102. It will be understood, that the laser score 50 may penetrate through to the cladding layer 104b or merely partially into the cladding layer 104a, as desired. The laminated glass article 100 also may be provided with an initiation defect 48 to facilitate scoring of the laminated glass article 100 and separation of the various portions of the laminated glass article 100 at the laser score 50.

A cooling nozzle 52 also may be utilized to cool the laminated glass article 100 after the laser vent 50 has been created.

FIG. 8 is a top view of a laminated glass article 100 being cut according to one embodiment of the present disclosure. The laminated glass article 100 is shown with a laser heated zone 64 created by the laser beam (pre-heat) 58 and the laser beam (score) 60. The laser beam (pre-heat) 58 and the laser beam (score) 60 may overlap to optimize the heating of the laminated glass article 100 and reduce any heat loss that may be associated with a separation between the laser beam (pre-heat) 58 and the laser beam (score) 60. In other words, in some embodiments, the laser beam (pre-heat) 58 creates a first footprint on the laminate glass article and the laser beam (score) 60 creates a second footprint on the laminate glass article, and the first footprint and the second footprint overlap.

The laser beam (pre-heat) 58 and the laser beam (score) 60 move in the pre-heating direction 36 to create a laser score 50 along the desired length of the laminated glass article 100.

A cooling beam 62 also is shown and may be implemented to cool the laminated glass article 100. The cooling beam is generated by the cooling nozzle 52 (FIG. 7).

Although preferential heating of the laminated glass article is described herein as being performed with a laser, other embodiments are included in this disclosure. For example, in some embodiments, the region of the laminated glass article is preferentially heated with a suitable heating device (e.g., a laser, a torch, an electric heater, or a combination thereof) to form the heated zone. Additionally, or alternatively, the region of the laminated glass article is preferentially heated without substantially heating a remote region of the laminated glass article spaced away from the cutting line.

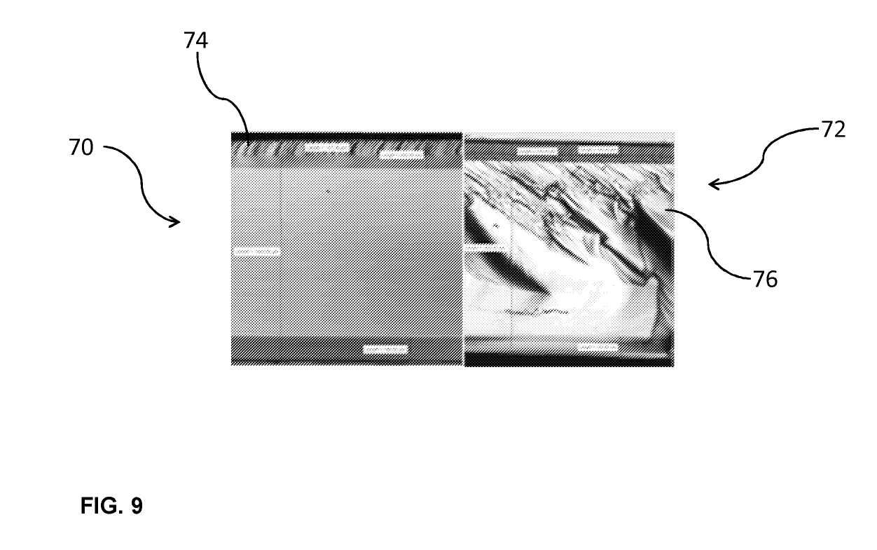

FIG. 9 is a cross-sectional picture comparing a laminated glass article 70 scored according to one embodiment of the present disclosure with a laminated glass article 72 scored at room temperature. The laminated glass article 70 was subjected to non-localized sheet heating to 300° C. and scored with a mechanical score wheel. The laminated glass article 72 was scored with a mechanical score wheel at room temperature, 20° C. The shallow score depth 74 in the laminated glass article 70 shows that the score wheel may not penetrate entirely through the clad. The edge breakage 76 of the laminated glass article 72 is indicative of the much higher stress present in the laminated glass article 72 due to the lower temperature during scoring. Thus, scoring the laminated glass article at elevated temperatures as described herein can enable severing of the laminated glass article with reduced breakage, which can enable improved edge quality at the severed edge of the laminated glass article.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method of cutting a laminate glass article, the method comprising:
heating at least a portion of the laminate glass article to form a heated portion, the laminate glass article comprising a core layer and a cladding layer adjacent to the core layer, wherein, prior to the heating, the laminate glass article comprises a stress resulting from a thermal property differential between the core layer and the cladding layer, and the stress of the laminate glass article is reduced in the heated portion in response to the heating;
scoring the laminate glass article in the heated portion to create a score in the laminate glass article along substantially an entire length of a cutting path, the cutting path defining a path in the laminate glass article where the cut is desired; and
applying a force to the laminate glass article at the score to cut the laminate glass article.

2. The method of claim 1, wherein, the heating step comprises heating the portion of the laminate glass article to a reheat temperature that is lower than a setting temperature of the laminate glass article.

3. The method of claim 1, wherein the stress of the laminate glass article in the heated portion is reduced by at least about 10% in response to the heating.

4. The method of claim 1, wherein the applying the force comprises bending the laminate glass article at the score.

5. The method of claim 1, wherein the applying the force comprises directing a cooling fluid toward the laminate glass article at the score.

6. The method of claim 1, wherein the thermal property differential comprises a coefficient of thermal expansion (CTE) differential between the core layer and the cladding layer.

7. The method of claim 1, wherein the stress comprises the core layer in tension and the cladding layer in compression.

8. The method of claim 1, wherein the stress comprises the core layer in compression and the cladding layer in tension.

9. The method of claim 1, wherein the heating step is performed by a laser beam and the scoring step is performed by a mechanical score wheel.

10. The method of claim 1, wherein the heating step is performed by a first laser beam and the scoring step is performed by a second laser beam.

11. The method of claim 10, wherein the first laser beam creates a first footprint on the laminate glass article, the second laser beam creates a second footprint on the laminate glass article, and the first footprint and the second footprint overlap each other.

12. The method of claim 1, further comprising the cooling the laminate glass article at the score after the heating step and before the applying the force step.

13. The method of claim 1, wherein the heating step comprises heating substantially the entire laminate glass article.

14. The method of claim 1, wherein the heating step comprises preferentially heating the portion of the laminate glass article without substantially heating a remote region of the laminate glass article spaced away from the cutting path.

15. The method of claim 1, wherein the cladding layer comprises a first cladding layer and a second cladding layer, and the core layer is disposed between the first cladding layer and the second cladding layer.

16. The method of claim 15, wherein the stress comprises the core layer in tension and each of the first and second cladding layers in compression.

17. The method of claim 15, wherein the stress comprises the core layer in compression and each of the first and second cladding layers in tension.

18. A method of cutting a laminate glass article, the method comprising:
heating at least a portion of the laminate glass article to form a heated portion, the laminate glass article comprising a core layer disposed between a first cladding layer and a second cladding layer, the laminate glass article comprising a coefficient of thermal expansion (CTE) mismatch between the core layer and each of the first cladding layer and the second cladding layer such that, prior to the heating, the laminate glass article comprises a stress, wherein the stress of the laminate glass article is reduced in the heated portion in response to the heating;
scoring the laminate glass article in the heated portion to create a score in the laminate glass article along an entire length of a cutting path, the cutting path defining a path in the laminate glass article where the cut is desired; and
bending the laminate glass article at the score to sever the laminate glass article.

19. The method of claim 18, wherein the stress of the laminate glass article in the heated portion is reduced by at least about 10% in response to the heating.

20. A system comprising:
a heating unit configured to heat at least a portion of a laminate glass article to form a heated portion, the laminate glass article comprising a core layer and a cladding layer adjacent to the core layer, wherein, prior to the heating, the laminate glass article comprises a stress resulting from a thermal property differential between the core layer and the cladding layer, and the heating unit is configured to reduce the stress of the laminate glass article in the heated portion;
a scoring unit configured to score the laminate glass article in the heated portion and create a score in the laminate glass article along substantially an entire length of a cutting path, the cutting path defining a line in the laminate glass article where a cut is desired; and
a severing unit configured to apply a force to the laminate glass article at the score to sever the laminate glass article.
